(19) United States
(12) Patent Application Publication
(10) Pub. No.: US 2025/0217588 A1
(43) Pub. Date: Jul. 3, 2025

(54) GENERATIVE NEURAL NETWORK MODEL STYLE GUIDE MANAGEMENT

(71) Applicant: Microsoft Technology Licensing, LLC, Redmond, WA (US)

(72) Inventors: Gonzalo A. RAMOS, Kirkland, WA (US); Shiqian Rachel NG, Seattle, WA (US); Andrew James HUNTINGTON, London (GB); Richard Malcolm BANKS, Chertsey (GB); Adam D. TROY, Bothell, WA (US); Catherine YEH, Cambridge, MA (US)

(73) Assignee: Microsoft Technology Licensing, LLC, Redmond, WA (US)

(21) Appl. No.: 18/400,715

(22) Filed: Dec. 29, 2023

(51) Int. Cl. G06F 40/253; G06F 3/0484

(52) U.S. Cl. CPC G06F 40/253; G06F 3/0484

(57) ABSTRACT

A method for style guide management is described. A first user input is received from a user via a graphical user interface (GUI). The first user input identifies a writing sample having a textual style. A style guide is generated, based on the writing sample, having a description of a target style, based on the textual style, for input to a generative neural network model (GNNM). A profile representing the style guide and comprising a natural language format description is sent for display in the GUI. The style guide is modified based on an explicit indication of a style preference. A request for drafting assistance is sent to the GNNM, the request including the style guide for text generation according to the style guide by the GNNM. An output generated by the GNNM in response to the request is obtained. The output is sent to be displayed within the GUI.

### BACKGROUND

The emergence of Large Language Models (LLMs) is extending machine capabilities, even in realms like creativity once considered exclusive to humans. Although creative individuals may be excited to integrate LLMs into their creative process, they face various usability challenges. As LLMs become more prevalent and accessible to the public, more and more people are using them to assist in everyday tasks, writing being one of the most predominant. In addition to needing experience with prompt-engineering, existing LLM-powered writing systems can frustrate users due to their lack of personalization and control. This often leads to unsatisfactory results when collaboratively writing with LLMs: poorly formed outputs along with increased time and processing resources needed to obtain a desirable output. While style systems now exist for LLMs, they generally focus on learning semantics within existing text. This approach keeps the user out of the loop on developing a style, especially as the user's own personal style changes over time.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to modifying documents using a generative neural network model.

In one aspect, a method for style guide management is provided. The method comprises receiving a first user input from a user via a graphical user interface. The first user input identifies a writing sample having a textual style. The method also includes generating a style guide based on the writing sample using a generative neural network model, where the style guide is a description of a target style, based on the textual style, for input to the generative neural network model for text generation according to the style guide during output generation. The method further includes sending a profile that represents the style guide to the graphical user interface for display in an editing window of the graphical user interface, where the profile comprises a description of the style guide in a natural language format. The method also includes modifying the style guide based on a second user input from the user, via the graphical user interface, the second user input indicating an explicit indication of a style preference. The method also includes sending a request for drafting assistance to the generative neural network model, the request including the style guide for text generation according to the style guide by the generative neural network model during output generation. The method further includes obtaining an output generated by the generative neural network model in response to the request and based on the style guide and sending the output to the graphical user interface to be displayed within the graphical user interface.

In another aspect, another method for style guide management is provided. The method comprises receiving a plurality of user inputs from a user that identifies writing samples having respective textual styles. The method also comprises generating a style guide based on the writing samples using a generative neural network model, where the style guide is a description of a target style that is a hybrid of the textual styles. The method also comprises modifying the style guide based on a first user input from the user, via a graphical user interface, the first user input indicating an explicit indication of a style preference. The method also comprises sending a request for drafting assistance to the generative neural network model, the request including the style guide for text generation according to the style guide by the generative neural network model during output generation. The method also comprises obtaining an output generated by the generative neural network model in response to the request and based on the style guide and sending the output to the graphical user interface to be displayed within the graphical user interface.

In yet another aspect, a computing device is provided. The computing device comprises a processor and a non-transitory computer-readable memory, wherein the processor is configured to carry out instructions from the memory that configure the computing device to: receive a first user input from a user via a graphical user interface, wherein the first user input identifies a writing sample having a textual style; generate a style guide based on the writing sample using a generative neural network model, wherein the style guide is a description of a target style, based on the textual style, for input to the generative neural network model for text generation according to the style guide during output generation; send a profile that represents the style guide to the graphical user interface for display in an editing window of the graphical user interface, wherein the profile comprises a description of the style guide in a natural language format; modify the style guide based on a second user input from the user, via the graphical user interface, the second user input indicating an explicit indication of a style preference; send a request for drafting assistance to the generative neural network model, the request including the style guide for text generation according to the style guide by the generative neural network model during output generation; obtain an output generated by the generative neural network model in response to the request and based on the style guide; and send the output to the graphical user interface to be displayed within the graphical user interface.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows a block diagram of an example system for style guide management with assistance from a generative neural network model, according to an aspect.

FIG. 2 shows a diagram of an example graphical user interface provided by the system of FIG. 1, according to an example aspect.

FIG. 3 shows a diagram of an example graphical user interface provided by the system of FIG. 1 for style guide modification, according to an aspect.

FIG. 4 shows a diagram of an example graphical user interface provided by the system of FIG. 1 for explicit indications of style preference, according to an aspect.

FIG. 5 shows a diagram of an example graphical user interface provided by the system of FIG. 1 for an explicit style summary, according to an aspect.

FIG. 6 shows a diagram of an example graphical user interface provided by the system of FIG. 1 for a style comparison summary, according to an aspect.

FIG. 7 shows a flowchart of an example method for style guide management, according to an aspect.

FIG. 8 shows a flowchart of another example method for style guide management, according to an aspect.

FIG. 9 is a block diagram illustrating physical components (e.g., hardware) of a computing device with which aspects of the disclosure may be practiced.

FIG. 10 is a block diagram illustrating the architecture of one aspect of a computing device.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes various aspects of a style management system having a generative neural network model. The system provides an improved graphical user interface that reduces an amount of time needed to generate and modify a target style of text to be generated by the generative neural network model. Accordingly, an amount of time and/or processing resources needed to generate a document or other output by the generative neural network model using the target style is also reduced. Although the system uses and may automatically create a style guide that is a description of the target style, the system also allows a user to provide explicit indications of style preference to be incorporated into the style guide. Moreover, the system allows a user to directly modify a profile in a natural language format to make changes to the target style.

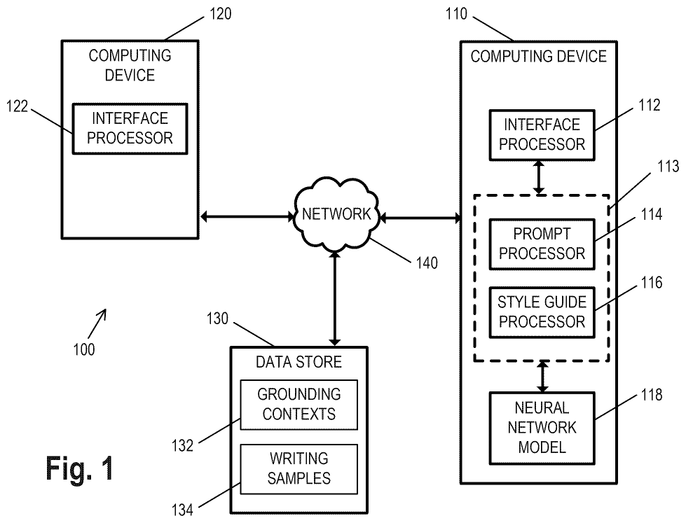

This and many further embodiments for a computing device are described herein. For instance, FIG. 1 shows a block diagram of an example system 100 for style guide management with assistance from a generative neural network model, according to an aspect. The system 100 comprises a computing device 110, a computing device 120, and a data store 130. A network 140 communicatively couples the computing device 110, the computing device 120, and the data store 130. The network 140 may comprise one or more networks such as local area networks (LANs), wide area networks (WANs), enterprise networks, the Internet, etc., and may include one or more of wired, wireless, and/or optical portions.

The computing device 110 comprises an interface processor 112, an intermediary 113 having a prompt processor 114 and a style guide processor 116, and a generative neural network model (GNNM) 118. The computing device 110 may be any suitable type of computing device, including a desktop computer, PC (personal computer), smartphone, tablet, or other computing device. In other examples, the computing device 110 may be a server, distributed computing platform, or cloud platform device. The computing device 110 may be configured to execute one or more software applications (or “applications”) and/or services and/or manage hardware resources (e.g., processors, memory, etc.), which may be utilized by users of the computing device 110.

The interface processor 112 is configured to generate a graphical user interface (GUI) 200 for displaying data to a user and receiving inputs from the user. Generally, the GUI 200 shows content in windows, provides user interface controls (e.g., buttons, drop-down menus, etc.), and receives user inputs (e.g., typed text, mouse clicks, etc.) corresponding to user interactions with the GUI 200. In some examples, the interface processor 112 uses or incorporates a suitable voice to text conversion module (not shown) for voice capture, allowing the user to provide spoken commands as user inputs. In some examples, the interface processor 112 processes the user inputs (e.g., converting an index of a drop-down box into plain text, providing formatting, converting multiple inputs into a data structure, etc.) and provides the processed user inputs to the intermediary 113. The interface processor 112 may be implemented as a web browser, software executable, app, or other suitable GUI tool.

Although the description herein refers to a single user, the features of the system 100 described herein are applicable to two, three, or more users that collaborate on documents and/or share style guides. In some examples, a style guide is shared among multiple users. In other examples, each user is associated with a separate style guide. In one such example, a style guide may be modified and used by a first user, but only used by a second user. Other variations on permissions and/or use of the style guide will be apparent to those skilled in the art.

The intermediary 113 is configured to communicate with the interface processor 112 and the GNNM 118, for example, using one or more suitable application programming interfaces (not shown). Generally, the intermediary 113 processes inputs received by the interface processor 112 and communicates with the GNNM 118 to obtain an output generated by the GNNM 118. For example, the intermediary 113 may generate prompts for the GNNM 118 based on the user inputs and provide a corresponding output to the interface processor 112. In this way, the user does not need to have experience with prompt engineering for obtaining an output from the GNNM 118. Moreover, the intermediary 113 may provide at least some insulation between the interface processor 112 and the GNNM 118, so that when changes to the GNNM 118 are made, such as upgrades, new versions, new weights, different models, and/or additional models, corresponding changes to the interface processor 112 are either not needed or are reduced in complexity.

As described above, the intermediary 113 comprises the prompt processor 114 and the style guide processor 116. The prompt processor 114 is configured to generate prompts to be provided as inputs to the GNNM 118. Generally, the prompt processor 114 generates the prompts based on the user inputs from the interface processor 112. In some examples, the prompt processor 114 generates the prompts based on the user inputs and also one or more grounding contexts. Examples of grounding contexts include objective information such as documents, articles, website content, excerpts of information, descriptions of subjects or textual styles, or other generally factual or objective sources, and may also include subjective information, such as text provided by the user that describes their current mood, design preferences, writing style preferences, or other subjective information. In some examples, the prompt processor 114 and/or the style guide processor 116 operate asynchronously relative to the interface processor 112, for example, to allow the user to interact with the GUI 200 while prompts are generated and sent to the GNNM 118, outputs are generated by the GNNM 118, and/or the outputs are processed.

In some examples, the prompt processor 114 may further process outputs from the GNNM 118 before providing the output to the interface processor 112. In one example, the prompt processor 114 performs formatting changes to the output, such as font changes, display styles, etc. Formatting changes may be performed by inserting markup language (e.g., XML, HTML) inline into the output, or by generating a suitable data structure that identifies formatting changes to be applied by the interface processor 112. In another example, the prompt processor 114 combines the output from the GNNM 118 with other data or information, such as previously obtained outputs from the GNNM 118, outputs from a different instance of the GNNM 118, portions of grounding contexts 214 (described below), or other suitable information. In one such example, the prompt processor 114 combines a text output from an LLM with an image generated by a StyleGAN and provides the combined text output and image to the interface processor 112.

One example of a grounding context is a style guide, which is a description in a natural language format of a textual style (“target style”) for text generation by the GNNM 118 during output generation. In the examples described herein, the style guide provides guidance to the GNNM 118 for writing form and structure, while other grounding contexts provide guidance for semantics, story, perspective, etc. In other examples, guidance from the style guide may overlap with guidance provided by the other grounding contexts. For example, a style guide may incorporate a background story and perspective for a subject or character within an output generated by the GNNM 118.

The style guide comprises style elements that instruct the GNNM 118 how to generate an output with the target style. Examples of the style elements for a text output include a description of a tone (e.g., enthusiastic, somber, melodramatic), voice (e.g., active or passive voice), word choice (e.g., short and simple words, evocative, visually descriptive words, etc.), sentence structure (e.g., simple or compound sentences, varied sentence structures), paragraph structure (e.g., a specific sequence of sentence types within a paragraph, such as introduction, body, conclusion), or other suitable style elements. Examples of the style elements for an image output include color preferences, brush styles (e.g., pencil, paintbrush, preferred blending modes), generation style (e.g., photographic, anime, cartoon, watercolor), image aspect ratios (e.g., portrait, landscape, wide angle), preferred subjects (e.g., people, natural landscapes, cats), or other suitable style elements.

In some examples, the style guide also includes a representation of a person or subject that communicates with the target style, and has a particular education, experience, skills, expertise, personality traits, work style, communication style, preferences, or other characteristics. The subject may be entirely fictional or based at least in part on an actual person.

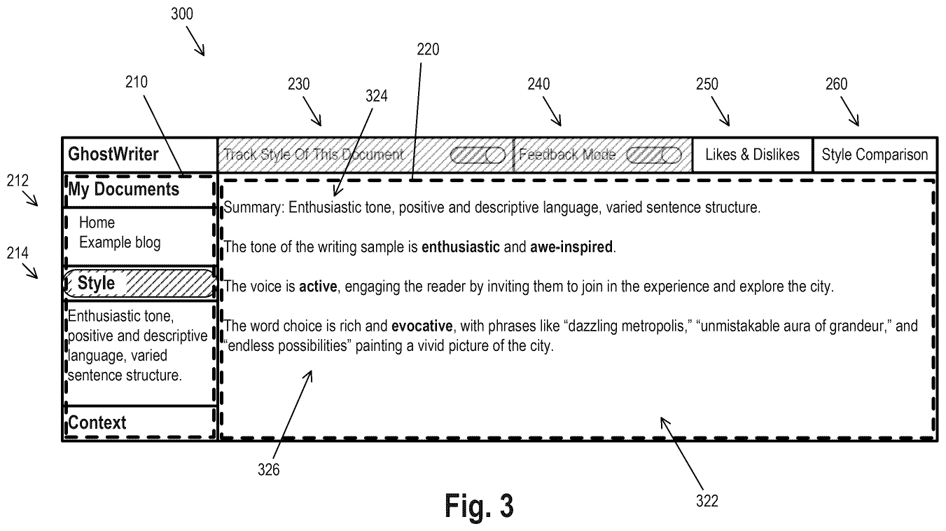

The style guide may be formatted as a profile, such as the profile 322 shown in FIG. 3. In other examples, the style guide is formatted in a data structure (e.g., JSON, XML, etc.) to have a reduced size, but is displayed for editing by the user in a profile format as shown in FIG. 3 for improved usability.

In some aspects, the grounding contexts comprises a document context that describes facts or information on which a document being drafted by the user should be based. The document context may be written in a natural language format and include a problem description for the document (e.g., why the document is being drafted), goals for the document (e.g., appearance, style, length, organization), milestones for development of the document (e.g., steps to be followed when drafting and revising the document), or other suitable information.

In some aspects, the grounding contexts comprises a user context that is specific to a user drafting a document. The user context, in some examples, may include factual information that describes the user's education, background, experiences. The user context may also include subjective information as described above (e.g., their current mood, design preferences, writing style preferences). Generally, the user context includes or identifies supporting materials to be used by the GNNM 118 during content generation.

The style guide processor 116 is configured to generate style guides for use by the prompt processor 114. In some examples, the style guide processor 116 generates a style guide based on user inputs received from the user via the GUI 200. In one example, the user may enter a text description of the style guide. In another example, the user may provide an indication of one or more writing samples having respective textual styles and the target style is based on the textual styles. In various examples, the writing samples may be written by the user, written by a different user or person, generated by a neural network model, or may be a hybrid of these samples (e.g., generated and/or modified by both people and neural network models). The writing samples may include all of, or a portion of, documents within the system 100 (e.g., written by the user or the GNNM 118) or other documents, such as books, articles, web pages, blog posts, etc. A first writing sample may be an excerpt from a book, a second writing sample may be an entire document written by the GNNM 118 and modified by a user, a third writing sample may be an excerpt from a news article, etc. In the example shown in FIG. 1, writing samples 134 are stored within the data store 130, but may be stored on the computing device 110, the computing device 120, and/or another suitable device, in other examples.

In some aspects, the user may enter a name of a person (e.g., historical figure such as Abraham Lincoln) or a description of the person (e.g., “a famous US president”) and the style guide processor 116 provides the user input to the GNNM 118 to generate the style guide. For example, the GNNM 118 may automatically select writing samples associated with the named person from the user input and generate an appropriate style guide. When generating a style guide, the style guide processor 116 may provide one or more style guide templates that define a structure and/or content of the style guide.

Although the prompt processor 114 and the style guide processor 116 are shown as separate components contained within the intermediary 113, the prompt processor 114 and the style guide processor 116 may be provided on separate computing devices (e.g., the computing device 120 or another instance of the computing device 110) in some examples. In still other examples, the prompt processor 114 and the style guide processor 116 are combined into a single module or executable.

In some examples, the intermediary 113 stores data and/or documents within the data store 130 (e.g., grounding contexts 132). For example, the intermediary 113 may store document contexts, user contexts, style guides, or other suitable information in the data store 130. Storing the data and/or documents relieves the user from having to manage which instance of the GNNM 118 has been provided with which data and/or documents. Moreover, the data and/or documents may be provided to the GNNM 118 over different generation sessions of the GNNM 118. Generally, an instance of the GNNM 118 does not permanently store data received within a generation session, such as a chat session with a chatbot interface of the GNNM 118. Storing the data and/or documents improves consistency in the output provided by the GNNM 118, reducing time needed by the user to generate and modify a document. Moreover, use of the stored data and/or documents (e.g., the grounding contexts) may reduce a number of interactions with the GNNM 118 used by the user during generation of the document, reducing signaling to the GNNM 118 and processing resources used by the GNNM 118.

Advantageously, the grounding contexts (style guides, document context, user context) may be displayed to the user via the GUI 200, for example, as a text document. Moreover, the user may provide user inputs via the GUI 200 to modify the grounding contexts, for example, to revise or update information, add new information, etc. The intermediary 113 may then store the updated grounding contexts for later use (e.g., when generating prompts by the prompt processor 114).

As described above, the GNNM 118 is a neural network model configured to generate an output based on prompts from the intermediary 113. The generated output may be text, images, videos, or a combination thereof. In some examples, the GNNM 118 is implemented as a large language model (LLM) that processes prompts and inputs, and provides a text-based output (e.g., output 228). For example, the GNNM 118 is configured to process prompts or inputs that have been written in natural language or suitable text data format, or may also process prompts containing programming language code, scripting language code, text (formatted or plain text), pseudo-code, XML, HTML, JSON, images, videos, etc. Examples of the LLM include OpenAI Generative Pre-trained Transformer (GPT), Big Science Large Open-science Open-access Multilingual Language Model (BLOOM), Large Language Model Meta AI (LlaMA) 2, Google Pathways Language Model (PaLM) 2, Google Gemini, or another suitable LLM.

In some examples, the GNNM 118 may be implemented as a transformer model (e.g., Generative Pretrained Transformer), for example, or other suitable model. In other examples, the GNNM 118 is configured for image generation and may be implemented as a diffusion model (e.g., Stable Diffusion), generative adversarial network (e.g., StyleGAN), neural style transfer model, large language model modified for image generation (e.g., DALL-E, Midjourney), or other suitable generative neural network model.

Although only one instance of the GNNM 118 is shown for clarity, the computing device 110 may comprise two, three, or more instances of the GNNM 118 to provide various processing tasks, such as document drafting assistance, image drafting assistance, or other suitable tasks. Although the GNNM 118 is shown as part of the computing device 110, instances of the GNNM 118 may be implemented on the computing device 120, the data store 130, a standalone computing device (not shown), a distributed computing device (e.g., cloud service), or other suitable processor.

In some examples, the interface processor 112 that provides the GUI 200 is located remotely from the intermediary 113 and/or the GNNM 118. For example, the computing device 120 may be a desktop computer, PC (personal computer), smartphone, or tablet having an interface processor 122 that generally corresponds to the interface processor 112.

The interface processor 112, the prompt processor 114, and the style guide processor 116 may be implemented as software modules, application specific integrated circuits (ASICs), firmware modules, or other suitable implementations, in various embodiments. The data store 130 may be implemented as one or more of any type of storage mechanism, including a magnetic disc (e.g., in a hard disk drive), an optical disc (e.g., in an optical disk drive), a magnetic tape (e.g., in a tape drive), a memory device such as a random access memory (RAM) device, a read-only memory (ROM) device, etc., and/or any other suitable type of storage medium.

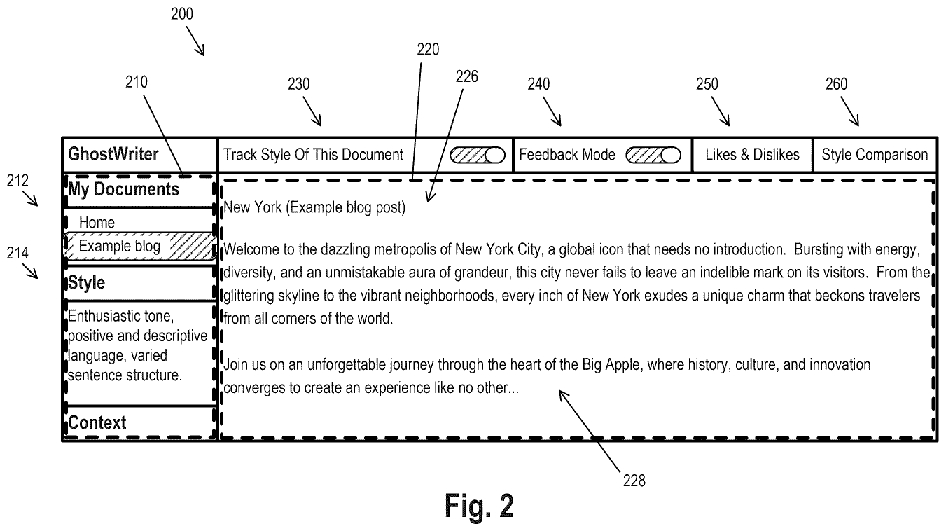

FIG. 2 shows a diagram of an example graphical user interface (GUI) 200 provided by the system of FIG. 1, according to an example aspect. The GUI 200 comprises a context sidebar 210 and an editing window 220. Generally, the context sidebar 210 provides a listing of documents 212 and/or grounding contexts 214 that are available to the user. In the example shown in FIG. 2, the grounding contexts 214 include a style guide (“Style”), and other contexts. Although only one style guide is shown in FIG. 2 for clarity, the grounding contexts 214 may comprise a plurality of style guides that are selectable by a user. In some examples, the plurality of style guides represent different textual styles, for example, for different types of documents to be generated (e.g., technical documents, marketing documents, fictional documents), for different characters or subjects within a fictional document, or other suitable purposes.

Generally, the editing window 220 displays content 226 of a document (document content) during an editing session of the document for the user, or content of a profile for a style guide. Outputs, such as the output 228, from the GNNM 118 may also be added to the editing window 220. In some examples, the editing session for a document begins when a user opens the document for viewing or modification and ends when the user closes the document. In some examples, the document may remain open and the editing session remains active even when the document is not actively displayed, such as when the editing window 220 loses focus (e.g., another application has taken control of user inputs), or the document is moved to a background tab (not shown) within the GUI 200. In addition to documents, the editing window 220 may display grounding contexts (e.g., user contexts, document contexts, style guides). As described above, the editing window 220 shown in FIG. 3 displays a profile 322 of a style guide. The user may modify the profile 322 by typing directly within the editing window, pasting text or images, or providing other suitable user input.

The GUI 200 also includes one or more options for managing textual styles and style guides. In the example shown in FIG. 2, the GUI 200 includes a document tracking option 230, a feedback mode option 240, an explicit style summary 250, and a style comparison 260. The document tracking option 230 includes an on/off toggle that allows a user to select whether a currently displayed document within the editing window 220 will be monitored by the style guide processor 116. When the document tracking option 230 is turned on, the style guide processor 116 is configured to determine a difference between a target style that corresponds to a currently selected style guide and a current style of the currently displayed document (e.g., a currently monitored document). For example, as a user writes within a document, their style may occasionally change or diverge from the target style.

The style guide processor 116 is configured to identify changes within the current style and determine a difference between the current style and the target style (or between two or more selected style guides). When the difference meets a style threshold, the style guide processor 116 may automatically update the current style guide (i.e., updating the target style), prompt the user for an update to the current style guide, or provide another suitable notification to the user. To determine the differences, the style guide processor 116, alone or in combination with the prompt processor 114, may provide a writing sample (e.g., an excerpt or entirety) from the currently selected document and the current style guide to the GNNM 118. In some examples, the style guide processor 116 provides one or more templates to the GNNM 118 to format the output from the GNNM 118 when determining the difference in styles. In various examples, the output may include a similarity score (e.g., 6 out of 10 style elements are similar, 20% of style elements are different), a summary of style elements that are the same or different, or other suitable information. In some examples, style elements have individual weights or priorities that affect the similarity score.

Although not shown in FIG. 2, in some examples the GUI 200 further comprises a style lock button that allows the user to lock, or stop modification, of the current style guide. In some examples, activating the style lock button causes the style guide processor 116 to stop monitoring documents for changes in the style guide. The GUI 200 may also include a style update button that causes the style guide processor 116 to determine the difference between the current style and the target style and update the target style, as described above.

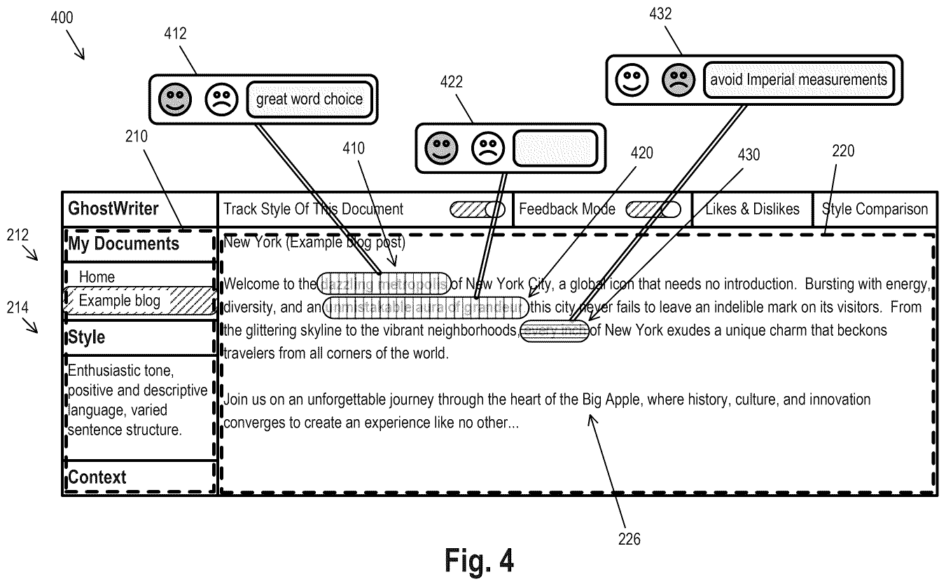

The feedback mode option 240 includes an on/off toggle that allows a user to select whether a currently displayed document within the editing window 220 will have visual indicators displayed for text portions associated with explicit indications of style preferences. For example, the user may provide an explicit indication of a style preference by highlighting a text portion of the document (e.g., a word, phrase, sentence, paragraph) and providing an indication of whether to increase or decrease a prioritization of a style for the text portion. Examples of the visual indicators may include underlining, bolding, font colors, bounding boxes, or other suitable indications. One example of bounding boxes is shown in FIG. 4, described below.

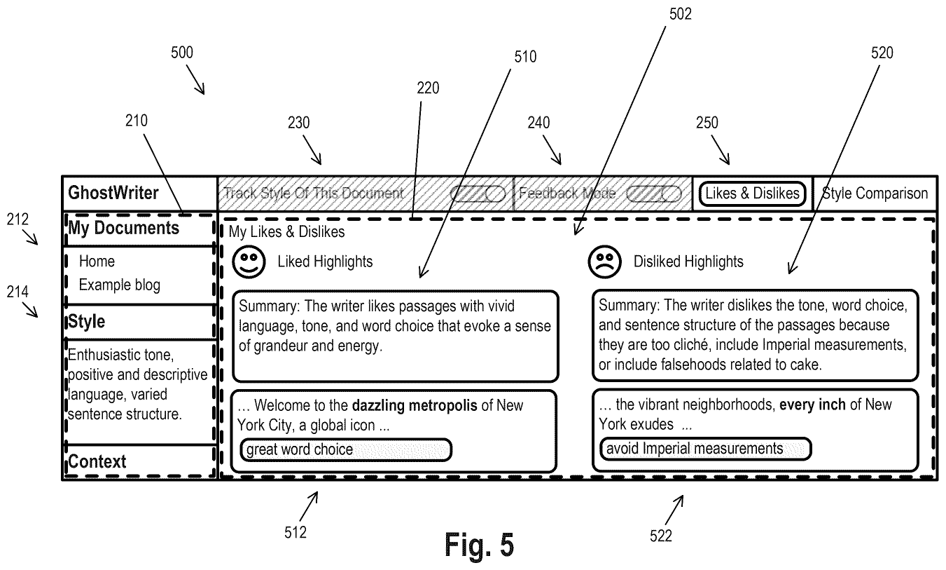

The explicit style summary 250 is a menu option that causes the editing window 220 to display information associated with explicit indications of style preferences by the user. As described above, the user may highlight text portions and provide indications of how to prioritize corresponding styles for the text portions. An example of an explicit style summary 502 is shown in FIG. 5, described below.

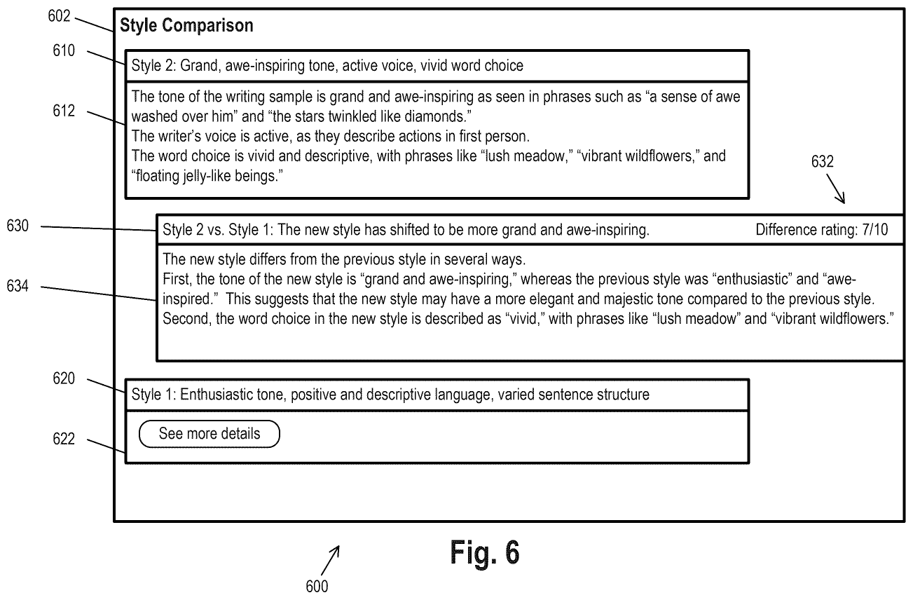

The style comparison 260 is a menu option that causes the editing window 220 to display information associated with differences between two or more style guides. As described above, the style guide may be changed over time or multiple style guides may be available, so a comparison of different versions of a style guide may be provided. Additionally or alternatively, different style guides may be available for selection by a user and comparison. A style comparison summary 602 (shown in FIG. 6) may be generated by the style guide processor 116 and provide a comparison of style elements for different style guides.

FIG. 3 shows a diagram of an example graphical user interface 300 provided by the system of FIG. 1 for style guide modification, according to an aspect. The GUI 300 generally corresponds to the GUI 200 and shows that the user has selected the “Style” grounding context. As described above, the style guide may be formatted the profile 322 or as a data structure in various examples. The style guide processor 116 may process the data structure, alone or in combination with the GNNM 118, to generate the profile 322.

Generally, the profile 322 is a description of the style guide in a natural language format. In the example shown in FIG. 3, the profile 322 includes a high level summary 324 along with specific examples 326 of style elements, such as tone, voice, word choice, and sentence structure. Other style elements may be included in other examples. To improve usability and efficiency when changing styles, the GUI 200 is configured to receive user inputs, via the editing window 220, that indicate explicit modifications to the profile 322. For one example, a user may change “The voice is active, engaging . . . ” to “The voice is mostly active, but occasionally passive” to indicate a preference for occasional use of passive voice. In another example, the user may add a formatting change, such as bolding or underlining, to indicate a prioritized preference for a style element. In still other examples, the user may delete portions of the profile 322 and/or add new portions to the profile 322.

FIG. 4 shows a diagram of an example graphical user interface 400 provided by the system of FIG. 1 for explicit indications of style preference, according to an aspect. The GUI 400 generally corresponds to the GUI 200 and shows that the user has selected a portion 410 of the document content 226 and, via a suitable user input in the GUI 400, caused the interface processor 112 to generate a feedback window 412. Generally, the feedback window 412 is an editing window providing one or more options for prioritization of a style element within the selected portion 410. In the example shown in FIG. 3, the feedback window 412 includes a “smiley face” icon that is selectable (and shown selected) by the user to indicate that they like, or wish to increase a priority level, of a style element within the selected portion 410. The feedback window 412 also includes a “frown face” icon that is selectable (shown unselected) by the user to indicate that they dislike, or wish to decrease a priority level, of a style element within the selected portion 410.

In some examples, the feedback window 412 optionally includes a basis prompt into which the user may enter a description in a natural language format of a basis for prioritizing the style element. In the example shown in FIG. 4, the user has provided a basis of “great word choice” to indicate that they like the words “dazzling metropolis.” Another example of a feedback window 422 is shown for a selected portion 420, where the user has indicated that they like the words “unmistakable aura of grandeur,” but without providing a basis. In some examples, when the user does not provide a basis, the prompt processor 114 generates a suitable prompt for the GNNM 118 to generate the basis as an output. Yet another example of a feedback window 432 is shown for a selected portion 430, where the user has indicated that they dislike the words “every inch,” with a basis of “avoid Imperial measurements.” Generally, the style guide processor 116 updates the style guide according to the user inputs from the feedback windows 412, 422, and 432. In some examples, using the basis allows the style guide processor 116 to generate the style guide to include more broadly applicable guidelines or rules for styles to be followed. For example, the style guide processor 116 may modify the style guide to indicate that Imperial measurements in general should be avoided, including not just inches (as specified by the user), but also references to feet, pounds, miles, etc.

In various examples, the feedback windows 412, 422, and 432 may be displayed outside of the editing window 220 (as shown in FIG. 4) or within the editing window 220 (e.g., over a top of the content 226). In one example, the feedback windows 412, 422, and 432 are generally hidden from view, but are displayed when the user “mouses over” the corresponding selected portion 410, 420, and 430. Other variations of displaying the feedback windows 412, 422, and 432 will be apparent to those skilled in the art.

FIG. 5 shows a diagram of an example graphical user interface 500 provided by the system of FIG. 1 for an explicit style summary 502, according to an aspect. The GUI 500 generally corresponds to the GUI 200 and shows that the user has selected the explicit style summary 250. In response to selection, the interface processor 112 displays the explicit style summary 502 within the editing window 220 and, in some examples, temporarily disables the document tracking option 230 and the feedback mode option 240.

Generally, the explicit style summary 502 shows information associated with explicit indications of style preferences received from the user. In the example shown in FIG. 5, the explicit style summary 502 includes a summary 510 of “likes,” or style elements to have increased priority, such as the style elements corresponding to the selected portions 410 and 420. The explicit style summary 502 also includes a summary 520 of “dislikes,” or style elements to have decreased priority, such as the style elements corresponding to the selected portion 430. In some examples, the style guide processor 116, alone or in combination with the prompt processor 114, generates a prompt to the GNNM 118 to generate the summaries 510 and 520 based on the selected portions of writing samples for a given style guide. The explicit style summary 502 may also include a listing of individual selected portions of the writing samples, such as the portion 512 (corresponding to the selected portion 410) and the portion 522 (corresponding to the selected portion 430).

FIG. 6 shows a diagram of an example graphical user interface 600 provided by the system of FIG. 1 for a style comparison summary 602, according to an aspect. The GUI 600 generally corresponds to the GUI 200 and shows that the user has selected the style comparison 260. For clarity, only the style comparison summary 602 is shown in FIG. 6, but the style comparison summary 602 may be displayed as a standalone window, or within the editing window 220, in various examples.

The style comparison summary 602 is generated by the style guide processor 116, alone or in combination with the prompt processor 114 and the GNNM 118, based on the different style guides. For example, the style guide processor 116 may provide a prompt to the GNNM 118 that includes the style guides (Style 1, Style 2) along with a template for providing an output according to a format shown in FIG. 6. Generally, the style comparison summary 602 provides a comparison of style elements for different style guides. In the example shown in FIG. 6, the style comparison summary 602 provides a comparison of a newer version (Style 2) of a previous style (Style 1). In other examples, the style comparison summary 602 provides a comparison of other, unrelated style guides.

The style comparison summary 602 includes a summary 610 and a summary 620 for the different styles, generally corresponding to the summary 324. The style comparison summary 602 further includes specific examples 612 and 622, generally corresponding to the examples 326. In one example, the summary 610 and the examples 612 correspond to a profile, as described above. The style comparison summary 602 also includes a comparison summary 630, a difference rating 632, and a comparison detail 634. The comparison summary 630 includes a high level comparison of the different style guides using a natural language format. The difference rating 632 generally corresponds to the differences and similarity score described above. The similarity score may be based on a number of style elements that are the same or different, a prioritized ranking of style elements, structural similarity of sentences or paragraphs, similarity in word selection or complexity, or any other suitable metric. The comparison detail 634 includes a comparison of the specific examples 612 and 622 using a natural language format.

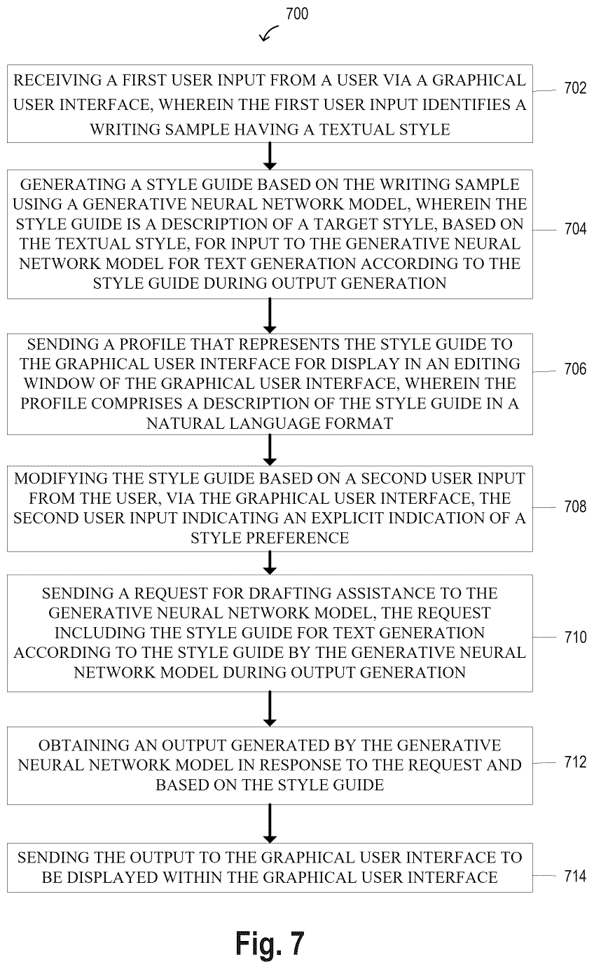

FIG. 7 shows a flowchart of an example method 700 for style guide management, according to an aspect. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 7. Steps may be performed serially, in a partially overlapping manner, or fully in parallel. Thus, the order in which steps of method 700 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 7 may be performed by the computing device 110 (e.g., via the interface processor 112, the prompt processor 114, the style guide processor 116), the computing device 120 (e.g., via the interface processor 122), or other suitable computing device.

Method 700 begins with step 702. At step 702, a first user input is received from a user via a graphical user interface. The first user input identifies a writing sample having a textual style. The graphical user interface may correspond to the GUI 200. In one example, the first user input is a selection by the user of the “Example blog” within the listing of documents 212. In another example, the first user input is a selection of another suitable document, such as a book, article, web page, blog post, etc. The first user input may correspond to a uniform resource locator (URL) for the writing sample, a network address, a local address (i.e., a directory location on a local device), or other suitable reference to a file.

In some examples, the writing sample is a document written by the user. In other words, the user selects documents they have written so that the target style matches their own style. In other examples, the writing sample was not written by the user. In some examples, the user selects other documents to create a hybrid style of several styles.

At step 704, a style guide is generated based on the writing sample using a generative neural network model. The style guide is a description of a target style, based on the textual style, for input to the generative neural network model for text generation according to the style guide during output generation. The generative neural network model may correspond to the GNNM 118. The style guide may be associated with the profile 322, for example, or another suitable style guide.

At step 706, a profile that represents the style guide is sent to the graphical user interface for display in an editing window of the graphical user interface. The profile comprises a description of the style guide in a natural language format. The editing window corresponds to the editing window 220 and the profile corresponds to the profile 322, for example.

At step 708, the style guide is modified based on a second user input from the user via the graphical user interface. The second user input indicates an explicit indication of a style preference. In some examples, the second user input is an explicit modification of the profile via the graphical user interface. For example, the user may modify the profile 322 by bolding, underlining, adding or removing text for a style element, or other modifications as described above. In some aspects, modifying the style guide includes prioritizing a style element within the profile based on the explicit modification of the profile. For example, the style elements for the selected portions 410 and 420 may be increased in priority, while the style element for the selected portion 430 may be decreased in priority, as described above.

At step 710, a request for drafting assistance is sent to the generative neural network model. The request includes the style guide for text generation according to the style guide by the generative neural network model during output generation. For example, the style guide processor 116, alone or in combination with the prompt processor 114, sends the style guide to the GNNM 118, along with suitable documents and/or grounding contexts as described above.

At step 712, an output is obtained, where the output is generated by the generative neural network model in response to the request and based on the style guide. The output may correspond to the output 228, for example. In some examples, the output is a continuation of the document. In other examples, the output is a new document. The method may further comprise merging the output into the document, for example, by inserting the output between existing content portions of the document or appending the output to the existing content portions.

At step 714, the output is sent to the graphical user interface to be displayed within the graphical user interface. In some examples, the prompt processor 114 processes the output before sending to the interface processor 112, as described above. For example, the prompt processor 114 may apply formatting changes to the output, such as font changes, display styles, insert markup language inline into the output, or combine the output with other data or information (e.g., previously obtained outputs, outputs from a different instance of the GNNM 118, portions of grounding contexts 214).

In some aspects, step 712 includes generating a prompt for the generative neural network model that includes the style guide and one or more of the document and one or more grounding contexts.

In some aspects, the method 700 further includes determining, using the generative neural network model, a difference between the target style and a current style of an additional writing sample written by the user, and automatically updating the style guide based on the current style when the difference meets a style update threshold. In another example, the user is prompted for an update to the style guide based on the current style when the difference meets the style update threshold. As described above, the style guide processor 116 may determine differences between styles, alone or in combination with the prompt processor 114 and the GNNM 118.

In some aspects, the second user input identifies an existing text portion of a document and the method 700 further comprises prioritizing, within the style guide, a style element of the existing text portion, including increasing or decreasing a priority level of the style element within the style guide. In these aspects, the second user input may correspond to the feedback windows 412, 422, and/or 432 with a corresponding increase or decrease in priority level according to whether the smiley face icon or frown face icon is selected, as described above. In some examples, the second user input includes a description in the natural language format of a basis for prioritizing the style element, such as the basis of “great word choice” in the feedback window 412.

In various examples, the output generated by the generative neural network model comprises one or more of source code, object notation, plain text. In one such example, the editing window is a text editing window and the generative neural network model is a large language model. In other examples, the output generated by the generative neural network model is an image portion. In one such example, the editing window is an image editing window and the generative neural network model is one of a generative adversarial network, a variational autoencoder, a diffusion model, or a text-to-image model.

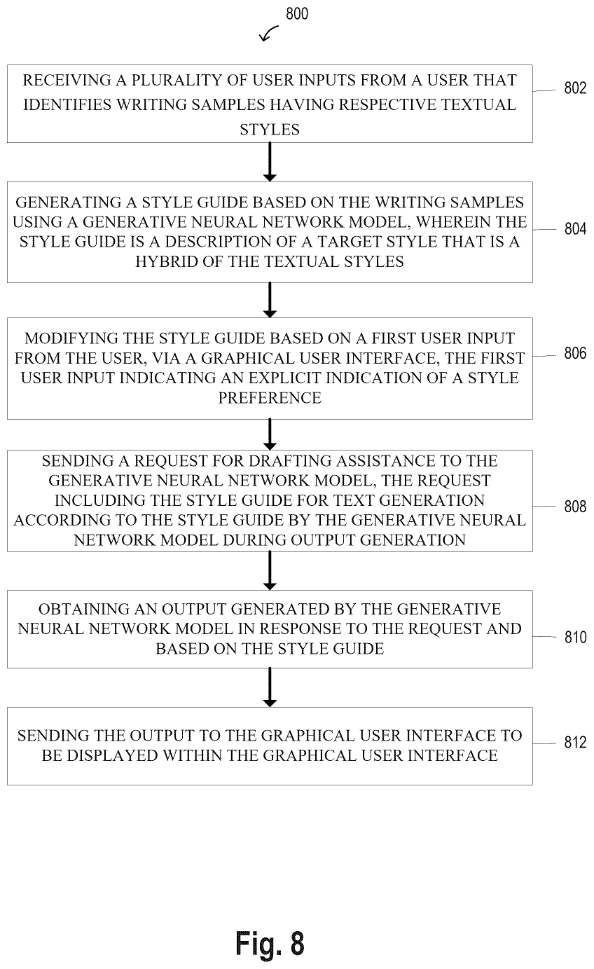

FIG. 8 shows a flowchart of another example method 800 for style guide management, according to an aspect. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 8. Steps may be performed serially, in a partially overlapping manner, or fully in parallel. Thus, the order in which steps of method 800 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 8 may be performed by the computing device 110 (e.g., via the interface processor 112, the prompt processor 114, the style guide processor 116), the computing device 120 (e.g., via the interface processor 122), or other suitable computing device.

Method 800 begins with step 802. At step 802, a plurality of user inputs are received from a user that identifies writing samples having respective textual styles. In one example, the plurality of user inputs include a selection by the user of the “Example blog” within the listing of documents 212. In another example, the plurality of user inputs include a selection of another suitable document, such as a book, article, web page, blog post, etc. The user inputs may correspond to a uniform resource locator (URL) for the writing sample, a network address, a local address (i.e., a directory location on a local device), or other suitable reference to a file.

At step 804, a style guide is generated based on the writing samples using a generative neural network model. The style guide is a description of a target style that is a hybrid of the textual styles. The generative neural network model may correspond to the GNNM 118. The style guide may be associated with the profile 322, for example, or another suitable style guide.

At step 806, the style guide is modified based on a first user input from the user via a graphical user interface. The first user input indicates an explicit indication of a style preference. The explicit indication may correspond to the selected portions 410, 420, and/or 430 and the feedback windows 412, 422, and/or 432, in some examples.

At step 808, a request for drafting assistance is sent to the generative neural network model. The request includes the style guide for text generation according to the style guide by the generative neural network model during output generation. For example, the style guide processor 116, alone or in combination with the prompt processor 114, sends the style guide to the GNNM 118, along with one or more of a document and/or grounding contexts as described above.

At step 810, an output is obtained, generated by the generative neural network model in response to the request and based on the style guide. The output may correspond to the output 228, for example. In some examples, the output is a continuation of the document provided to the GNNM 118. In other examples, the output is a new document. The method may further comprise merging the output into the document, for example, by inserting the output between existing content portions of the document or appending the output to existing content portions of the document.

At step 812, the output is sent to the graphical user interface to be displayed within the graphical user interface. In some examples, the prompt processor 114 processes the output before sending to the interface processor 112, as described above. For example, the prompt processor 114 may apply formatting changes to the output, such as font changes, display styles, insert markup language inline into the output, or combine the output with other data or information (e.g., previously obtained outputs, outputs from a different instance of the GNNM 118, portions of grounding contexts 214).

In some aspects, the method 800 further comprises generating a profile that comprises a description of the style guide in a natural language format. In some examples, the profile corresponds to the profile 322, for example. The profile is sent to the graphical user interface for display in an editing window of the graphical user interface, such as the editing window 220. A second user input is received, via the editing window, that comprises an explicit modification of the profile. The style guide is modified based on the explicit modification of the profile. In some examples, a style element is prioritized within the profile based on the explicit modification of the profile. In some examples, a style element is added to the profile based on the explicit modification of the profile. The second user input may correspond to changes directly to the profile 322 in the editing window 220, as described above.

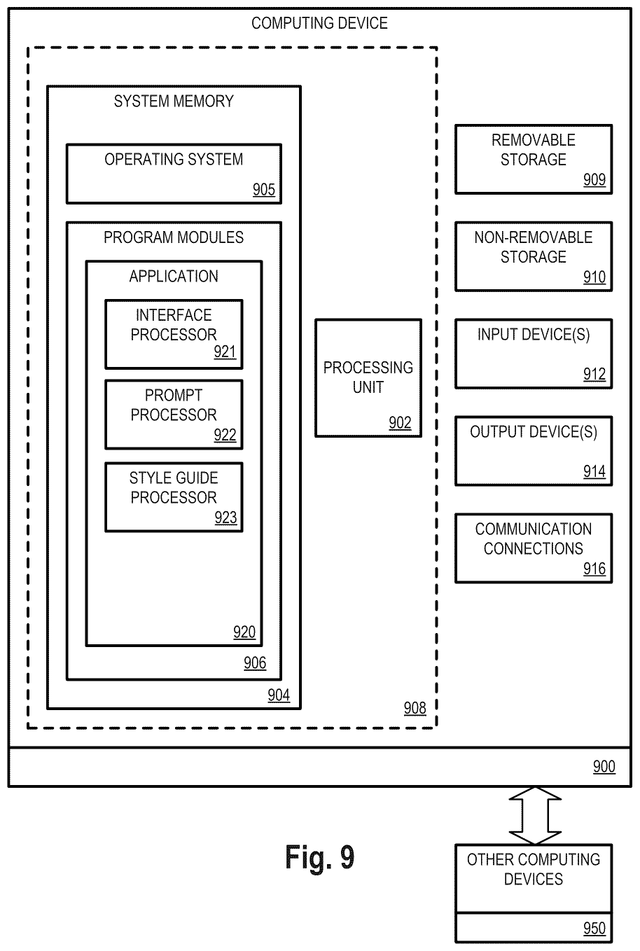

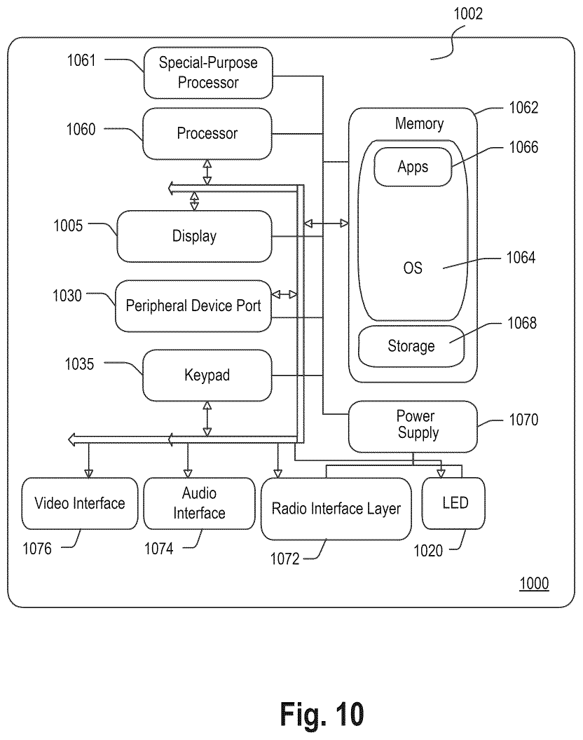

FIGS. 9 and 10 and the associated descriptions provide a discussion of a variety of operating environments in which aspects of the disclosure may be practiced. However, the devices and systems illustrated and discussed with respect to FIGS. 9 and 10 are for purposes of example and illustration and are not limiting of a vast number of computing device configurations that may be utilized for practicing aspects of the disclosure, as described herein.

FIG. 9 is a block diagram illustrating physical components (e.g., hardware) of a computing device 900 with which aspects of the disclosure may be practiced. The computing device components described below may have computer executable instructions for implementing a style guide management application 920 on a computing device (e.g., computing device 110), including computer executable instructions for style guide management application 920 that can be executed to implement the methods disclosed herein. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 and one or more program modules 906 suitable for running style guide management application 920, such as one or more components with regard to FIG. 1 and, in particular, interface processor 921 (e.g., corresponding to interface processor 112), prompt processor 922 (e.g., corresponding to prompt processor 114), and/or persona processor 923 (e.g., corresponding to style guide processor 116).

The operating system 905, for example, may be suitable for controlling the operation of the computing device 900. Furthermore, embodiments of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., style guide management application 920) may perform processes including, but not limited to, the aspects, as described herein. Other program modules that may be used in accordance with aspects of the present disclosure, and in particular for style guide management, may include interface processor 921, prompt processor 922, and persona processor 923.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 10 is a block diagram illustrating the architecture of one aspect of a computing device 1000. That is, the computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone. The system 1002 may include a display 1005 (analogous to output device 914), such as a touch-screen display or other suitable user interface. The system 1002 may also include an optional keypad 1035 (analogous to keypad 1035) and one or more peripheral device ports 1030, such as input and/or output ports for audio, video, control signals, or other suitable signals.

The system 1002 may include a processor 1060 coupled to memory 1062, in some examples. The system 1002 may also include a special-purpose processor 1061, such as a neural network processor. One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as email or other messages used by an email application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer.

The system 1002 has a power supply 1070, which may be implemented as one or more batteries. The power supply 1070 may further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via an audio transducer (not shown). In the illustrated embodiment, the visual indicator 1020 is a light emitting diode (LED) and the audio transducer may be a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of peripheral device port 1030 (e.g., for an on-board camera) to record still images, video stream, and the like.

A computing device 1000 implementing the system 1002 may have additional features or functionality. For example, the computing device 1000 may also include additional data storage devices (removable and/or non-removable) such as, magnetic disks, optical disks, or tape. Such additional storage is illustrated in FIG. 10 by the non-volatile storage area 1068.

Data/information generated or captured by the system 1002 may be stored locally, or the data may be stored on any number of storage media that may be accessed by the device via the radio interface layer 1072 or via a wired connection between the computing device 1000 and a separate computing device associated with the computing device 1000, for example, a server computer in a distributed computing network, such as the Internet. As should be appreciated such data/information may be accessed via the computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

As should be appreciated, FIG. 10 is described for purposes of illustrating the present methods and systems and is not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for style guide management, the method comprising:
receiving a first user input from a user via a graphical user interface, wherein the first user input identifies a writing sample having a textual style;
generating a style guide based on the writing sample using a generative neural network model, wherein the style guide is a description of a target style, based on the textual style, for input to the generative neural network model for text generation according to the style guide during output generation;
sending a profile that represents the style guide to the graphical user interface for display in an editing window of the graphical user interface, wherein the profile comprises a description of the style guide in a natural language format;
modifying the style guide based on a second user input from the user, via the graphical user interface, the second user input indicating an explicit indication of a style preference;
sending a request for drafting assistance to the generative neural network model, the request including the style guide for text generation according to the style guide by the generative neural network model during output generation;
obtaining an output generated by the generative neural network model in response to the request and based on the style guide; and
sending the output to the graphical user interface to be displayed within the graphical user interface.

2. The method of claim 1, wherein the writing sample is a document written by the user.

3. The method of claim 2, wherein the output generated by the generative neural network model is a continuation of the document; and
the method further comprises merging the output generated by the generative neural network model into the document.

4. The method of claim 3, wherein obtaining the output comprises generating a prompt for the generative neural network model that includes the style guide and one or more of the document and one or more grounding contexts.

5. The method of claim 2, the method further comprising:
determining, using the generative neural network model, a difference between the target style and a current style of an additional writing sample written by the user; and
automatically updating the style guide based on the current style when the difference meets a style update threshold.

6. The method of claim 2, the method further comprising:
determining, using the generative neural network model, a difference between the target style and a current style of an additional writing sample written by the user; and
prompting the user for an update to the style guide based on the current style when the difference meets a style update threshold.

7. The method of claim 1, wherein the writing sample was not written by the user.

8. The method of claim 1, wherein the second user input is an explicit modification of the profile via the graphical user interface.

9. The method of claim 8, the method further comprising prioritizing a style element within the profile based on the explicit modification of the profile.

10. The method of claim 8, the method further comprising adding a style element to the profile based on the explicit modification of the profile.

11. The method of claim 1, wherein the second user input identifies an existing text portion of a document; and
the method further comprises prioritizing, within the style guide, a style element of the existing text portion, including increasing or decreasing a priority level of the style element within the style guide.

12. The method of claim 11, wherein the second user input includes a description in the natural language format of a basis for prioritizing the style element.

13. A method for style guide management, the method comprising:
receiving a plurality of user inputs from a user that identifies writing samples having respective textual styles;
generating a style guide based on the writing samples using a generative neural network model, wherein the style guide is a description of a target style that is a hybrid of the textual styles;
modifying the style guide based on a first user input from the user, via a graphical user interface, the first user input indicating an explicit indication of a style preference;
sending a request for drafting assistance to the generative neural network model, the request including the style guide for text generation according to the style guide by the generative neural network model during output generation;
obtaining an output generated by the generative neural network model in response to the request and based on the style guide; and
sending the output to the graphical user interface to be displayed within the graphical user interface.

14. The method of claim 13, the method further comprising:
generating a profile that comprises a description of the style guide in a natural language format;
sending the profile to the graphical user interface for display in an editing window of the graphical user interface;
receiving a second user input, via the editing window, that comprises an explicit modification of the profile; and
modifying the style guide based on the explicit modification of the profile.

15. The method of claim 14, the method further comprising prioritizing a style element within the profile based on the explicit modification of the profile.

16. The method of claim 14, the method further comprising adding a style element to the profile based on the explicit modification of the profile.

17. A computing device, the computing device comprising a processor and a non-transitory computer-readable memory, wherein the processor is configured to carry out instructions from the memory that configure the computing device to:
receive a first user input from a user via a graphical user interface, wherein the first user input identifies a writing sample having a textual style;
generate a style guide based on the writing sample using a generative neural network model, wherein the style guide is a description of a target style, based on the textual style, for input to the generative neural network model for text generation according to the style guide during output generation;
send a profile that represents the style guide to the graphical user interface for display in an editing window of the graphical user interface, wherein the profile comprises a description of the style guide in a natural language format;
modify the style guide based on a second user input from the user, via the graphical user interface, the second user input indicating an explicit indication of a style preference;
send a request for drafting assistance to the generative neural network model, the request including the style guide for text generation according to the style guide by the generative neural network model during output generation;
obtain an output generated by the generative neural network model in response to the request and based on the style guide; and
send the output to the graphical user interface to be displayed within the graphical user interface.

18. The computing device of claim 17, wherein the processor is configured to carry out instructions from the memory that configure the computing device to:
determine, using the generative neural network model, a difference between the target style and a current style of an additional writing sample written by the user; and
automatically update the style guide based on the current style when the difference meets a style update threshold.

19. The computing device of claim 17, wherein the explicit indication of the style preference comprises an addition of a text description of a style element to the profile.

20. The computing device of claim 17, wherein the explicit indication of the style preference comprises a prioritization of a style element within the profile.
